(19) United States
(12) Patent Application Publication
(10) Pub. No.: US 2026/0080538 A1
(43) Pub. Date: Mar. 19, 2026

(54) RADIATION IMAGE PROCESSING DEVICE, RADIATION IMAGE PROCESSING METHOD, AND RADIATION IMAGE PROCESSING PROGRAM

(71) Applicant: FUJIFILM Corporation, Tokyo (JP)

(72) Inventor: Masahiro SAKURAI, Kanagawa (JP)

(73) Assignee: FUJIFILM Corporation, Tokyo (JP)

(21) Appl. No.: 19/324,890

(22) Filed: Sep. 10, 2025

(30) Foreign Application Priority Data
Sep. 19, 2024 (JP) 2024-162531

(51) Int. Cl. G06T 7/00

(52) U.S. Cl. CPC G06T 7/0014; G06T 2207/10116; G06T 2207/30101

(57) ABSTRACT

A processor is configured to acquire a post-contrast radiation image by performing radiography on the subject including a tubular structure injected with the contrast agent, derive a first scattered ray component on an incidence side of radiation of the subject and a second scattered ray component on an emission side of the radiation of the subject with reference to the tubular structure, and derive a post-contrast processed radiation image by removing the scattered ray component of the post-contrast radiation image based on the first scattered ray component and the second scattered ray component in a region of the tubular structure injected with the contrast agent in the post-contrast radiation image.

### CROSS REFERENCE TO RELATED APPLICATIONS

The present application claims priority from Japanese Patent Application No. 2024-162531, filed on Sep. 19, 2024, the entire disclosure of which is incorporated herein by reference.

### BACKGROUND

### Technical Field

The present disclosure relates to a radiation image processing device, a radiation image processing method, and a radiation image processing program.

### Related Art

In the related art, a contrast radiation image diagnostic apparatus has been used to examine a shape of a blood vessel, an abnormality of a blood vessel, a blood flow state, and the like, and perform treatment thereof. The contrast radiation image diagnostic apparatus is called an angiography apparatus. In the angiography apparatus, a contrast agent is injected into the blood vessel using a catheter, and a digital subtraction angiography (DSA) image, which is a difference image between an image (mask image) before the injection of the contrast agent and an image (live image) after the injection of the contrast agent, is acquired. In the DSA image, a structure other than a region in which the contrast agent is injected is removed. Therefore, by using the DSA image, a doctor can efficiently perform the examination and the treatment of the blood vessel while checking a distribution of the blood flow in the blood vessel and a state of the blood vessel, such as the stenosis of the blood vessel.

In the DSA image, the state of the blood vessel can be checked based on the region of the contrast agent injected into the blood vessel. However, due to an influence of scattered rays generated in a case in which radiation is transmitted through a subject, an unnecessary structure for observation, such as a bone that overlaps with the contrast agent in the subject, may not be completely removed by the difference, and may be included in the DSA image. Therefore, a method of removing scattered rays of an acquired image based on the concentration of the contrast agent and the thickness of the contrast agent has been proposed (see, for example, JP2016-202459A).

However, in the live image, the behavior of the scattered ray is different between the scattered ray component generated until the scattered ray reaches the blood vessel injected with the contrast agent in the subject and the scattered ray component generated after the scattered rays are transmitted through the blood vessel. For example, the effect of absorbing the scattered rays generated between the radiation source and the blood vessel by the contrast agent is large, but the scattered rays generated on a detector side with respect to the blood vessel are not absorbed by the contrast agent, and the influence of the scattered rays generated from the contrast agent is increased.

### SUMMARY OF THE INVENTION

The present disclosure has been made in view of the above circumstances, and an object of the present disclosure is to enable removal of a scattered ray component from an image by taking into account a position of the contrast agent in the subject.

A radiation image processing device according to the present disclosure includes:
a processor,
in which the processor is configured to:
   acquire a post-contrast radiation image by performing radiography on a subject including a tubular structure injected with a contrast agent;
   derive a first scattered ray component on an incidence side of radiation of the subject and a second scattered ray component on an emission side of the radiation of the subject with reference to the tubular structure; and
   derive a post-contrast processed radiation image by removing a scattered ray component of the post-contrast radiation image based on the first scattered ray component and the second scattered ray component in a region of the tubular structure injected with the contrast agent in the post-contrast radiation image.

In the radiation image processing device according to the present disclosure, the processor may be configured to derive each of the first scattered ray component and the second scattered ray component based on a first body thickness of the subject on the incidence side of the radiation with reference to the tubular structure on a transmission path of the radiation in the subject and a second body thickness on the emission side of the radiation with reference to the tubular structure on the transmission path.

In the radiation image processing device according to the present disclosure, the processor may be configured to derive the first scattered ray component based on a first coefficient that is determined according to a concentration of the contrast agent and that takes into account a scattered ray absorbed by the contrast agent, and derive the second scattered ray component based on a second coefficient that is determined according to the concentration of the contrast agent and that takes into account a scattered ray generated from the contrast agent.

In the radiation image processing device according to the present disclosure, the processor may be configured to derive other scattered ray components in other regions other than the tubular structure injected with the contrast agent in the post-contrast radiation image, and derive the post-contrast processed radiation image by removing the scattered ray components in the other regions in the post-contrast radiation image based on the other scattered ray components that are derived.

In the radiation image processing device according to the present disclosure,
the processor may be configured to:
   derive the first scattered ray component on the incidence side of the radiation of the subject and the second scattered ray component on the emission side of the radiation of the subject with reference to the tubular structure in the other regions; and
   derive the other scattered ray components based on the first scattered ray component and the second scattered ray component.

In the radiation image processing device according to the present disclosure, the processor may be configured to derive the post-contrast processed radiation image by removing the scattered ray component of the post-contrast radiation image only in the region of the tubular structure in the post-contrast radiation image.

In the radiation image processing device according to the present disclosure,
the processor may be configured to:
   acquire a pre-contrast radiation image by performing the radiography on the subject including the tubular structure before the contrast agent is injected;
   derive a pre-contrast scattered ray component included in the pre-contrast radiation image;
   derive a pre-contrast processed radiation image by removing a scattered ray component of the pre-contrast radiation image based on the pre-contrast scattered ray component; and
   derive a difference image between the pre-contrast processed radiation image and the post-contrast processed radiation image.

In the radiation image processing device according to the present disclosure,
the processor may be configured to:
   acquire a pre-contrast radiation image by performing the radiography on the subject including the tubular structure before the contrast agent is injected;
   derive a pre-contrast scattered ray component included in the region of the tubular structure of the pre-contrast radiation image;
   derive a pre-contrast processed radiation image by removing a scattered ray component in the region of the tubular structure of the pre-contrast radiation image based on the pre-contrast scattered ray component; and
   derive a difference image between the pre-contrast processed radiation image and the post-contrast processed radiation image.

A radiation image processing method according to the present disclosure includes:
via a computer,
acquiring a post-contrast radiation image by performing radiography on a subject including a tubular structure injected with a contrast agent;
deriving a first scattered ray component on an incidence side of radiation of the subject and a second scattered ray component on an emission side of the radiation of the subject with reference to the tubular structure; and
deriving a post-contrast processed radiation image by removing a scattered ray component of the post-contrast radiation image based on the first scattered ray component and the second scattered ray component in a region of the tubular structure injected with the contrast agent in the post-contrast radiation image.

A radiation image processing program according to the present disclosure causes a computer to execute:
a procedure of acquiring a post-contrast radiation image by performing radiography on a subject including a tubular structure injected with a contrast agent;
a procedure of deriving a first scattered ray component on an incidence side of radiation of the subject and a second scattered ray component on an emission side of the radiation of the subject with reference to the tubular structure; and
a procedure of deriving a post-contrast processed radiation image by removing a scattered ray component of the post-contrast radiation image based on the first scattered ray component and the second scattered ray component in a region of the tubular structure injected with the contrast agent in the post-contrast radiation image.

The technology of the present disclosure may be applied to a program product.

According to the present disclosure, it is possible to remove the scattered ray component from the image according to the position of the contrast agent in the subject.

### BRIEF DESCRIPTION OF THE DRAWINGS

FIG. 1 is a diagram showing an outline of an angiography system to which a radiation image processing device according to an embodiment of the present disclosure is applied.

FIG. 2 is a diagram showing a schematic configuration of the radiation image processing device according to the present embodiment.

FIG. 3 is a diagram showing a functional configuration of the radiation image processing device according to the present embodiment.

FIG. 4 is a diagram for describing derivation of position information of a blood vessel.

FIG. 5 is a diagram for describing extraction of a blood vessel region.

FIG. 6 is a diagram showing a relationship between an amount of a contrast agent and coefficients α and β.

FIG. 7 is a flowchart showing processing performed in the present embodiment.

FIG. 8 is a flowchart showing processing performed in the present embodiment.

FIG. 9 is a conceptual diagram of the processing performed in the present embodiment.

### DETAILED DESCRIPTION

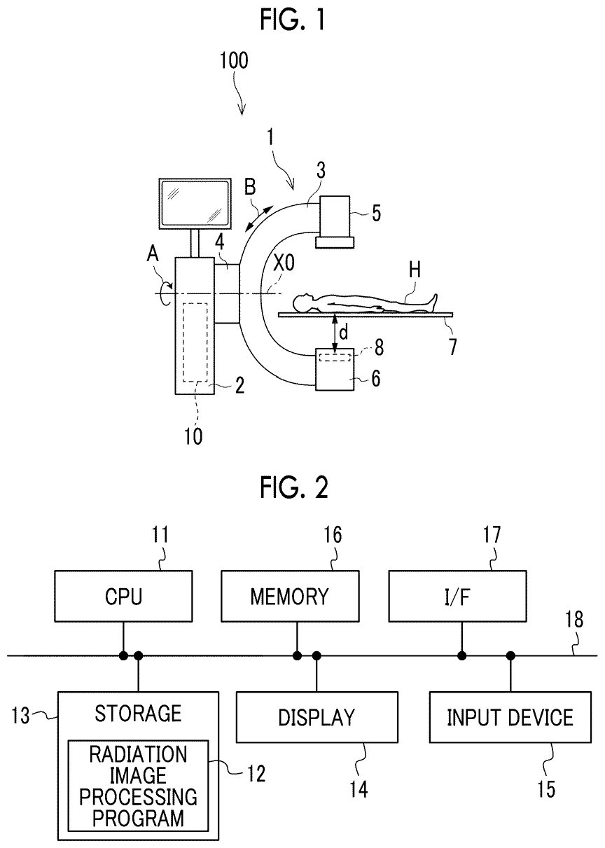

In the following description, an embodiment of the present disclosure will be described with reference to the drawings. FIG. 1 is a schematic block diagram showing a configuration of an angiography system to which a radiation image processing device according to the embodiment of the present disclosure is applied. As shown in FIG. 1, an angiography system 100 according to the present embodiment comprises an angiography apparatus 1 and a radiation image processing device 10 according to the present embodiment.

The angiography apparatus 1 is an apparatus for examining a shape of a blood vessel of a subject, an abnormality of the blood vessel, a state of blood flow, and the like, and performing the treatment thereof. In the present embodiment, the angiography apparatus 1 is used to perform the examination and the treatment of, for example, an aorta and an artery branched from the aorta. The angiography apparatus 1 includes a C-arm 3 that is attached to a body 2 by an attachment portion 4 to be rotatable around an axis X0, that is, in a direction of an arrow A. In addition, the C-arm 3 is attached to the attachment portion 4 to be movable in a direction of an arrow B shown in FIG. 1. A radiation source 5 is attached to one end part of the C-arm 3, and an imaging unit 6 is attached to the other end part of the C-arm 3. The imaging unit 6 is provided with a radiation detector 8 that detects radiation transmitted through a subject H on an imaging table 7 to generate a radiation image of the subject H. The body 2 includes the radiation image processing device 10 according to the present embodiment. The blood vessel is an example of a tubular structure.

In the present embodiment, the blood vessel is imaged by injecting a contrast agent. First, the subject H is imaged before the contrast agent is injected, to acquire a radiation image (hereinafter, referred to as a mask image) of the subject H before the contrast agent is injected. The subject H is imaged after the injection of the contrast agent, to acquire a radiation image (hereinafter, referred to as a live image) of the subject H after the injection of the contrast agent. The mask image is an example of a pre-contrast radiation image, and the live image is an example of a post-contrast radiation image.

Next, the radiation image processing device according to the present embodiment will be described. First, a hardware configuration of the radiation image processing device according to the present embodiment will be described with reference to FIG. 2. As shown in FIG. 2, the radiation image processing device 10 is a computer, such as a workstation, a server computer, and a personal computer, and comprises a central processing unit (CPU) 11, a non-volatile storage 13, and a memory 16 as a transitory storage region. In addition, the radiation image processing device 10 comprises a display 14 such as a liquid crystal display, an input device 15 such as a keyboard and a mouse, and a network interface (I/F) 17 connected to a network and the imaging unit 6. The CPU 11, the storage 13, the display 14, the input device 15, the memory 16, and the network I/F 17 are connected to a bus 18. It should be noted that the CPU 11 is an example of a processor according to the present disclosure.

The storage 13 is realized by a hard disk drive (HDD), a solid state drive (SSD), a flash memory, and the like. A radiation image processing program 12 installed in the radiation image processing device 10 is stored in the storage 13 as a storage medium. The CPU 11 reads out the radiation image processing program 12 from the storage 13, expands the read out radiation image processing program 12 to the memory 16, and executes the expanded radiation image processing program 12.

It should be noted that the radiation image processing program 12 is stored in a storage device of the server computer connected to the network or in a network storage in a state of being accessible from the outside, and is downloaded and installed in the computer that configures the radiation image processing device 10 in response to the request. Alternatively, the radiation image processing program 12 is distributed in a state of being recorded on a recording medium, such as a digital versatile disc (DVD) or a compact disc read only memory (CD-ROM), and is installed in the computer that configures the radiation image processing device 10 from the recording medium.

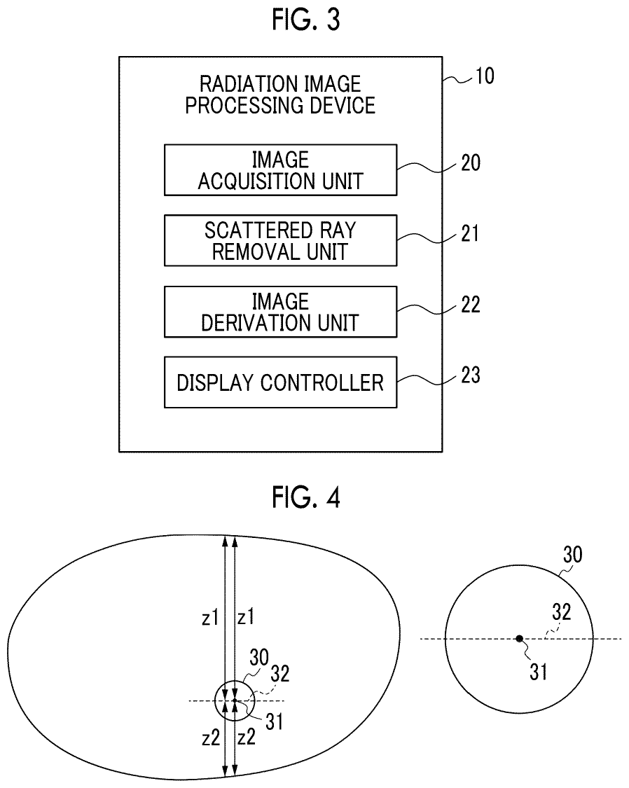

Next, a functional configuration of the radiation image processing device according to the present embodiment will be described. FIG. 3 is a diagram showing the functional configuration of the radiation image processing device according to the present embodiment. The radiation image processing device 10 comprises, as shown in FIG. 3, an image acquisition unit 20, a scattered ray removal unit 21, an image derivation unit 22, and a display controller 23. In a case in which the CPU 11 executes the radiation image processing program 12, the CPU 11 functions as the image acquisition unit 20, the scattered ray removal unit 21, the image derivation unit 22, and the display controller 23.

The image acquisition unit 20 acquires a mask image G1 and a live image G2 by causing the angiography apparatus 1 to image the subject H. In a case of the imaging, imaging conditions such as an irradiation dose of the radiation, a tube voltage, and a source-to-image receptor distance (SID) (distance between an X-ray tube focus and an image receiving surface) are set. The set imaging conditions are stored in the storage 13.

It should be noted that the mask image G1 and the live image G2 may be acquired by a program separate from the radiation image processing program according to the present embodiment. In this case, the mask image G1 and the live image G2 are stored in the storage 13, and the image acquisition unit 20 reads out the mask image G1 and the live image G2 stored in the storage 13 from the storage 13, for processing.

Here, in a case of imaging the subject H using the angiography apparatus 1, since the scattered rays are generated in a case in which the radiation passes through the subject H, a scattered ray component caused by the scattered rays is included in the mask image G1 and the live image G2. The mask image G1 is acquired before the injection of the contrast agent, but the live image G2 is acquired after the injection of the contrast agent. Since the contrast agent absorbs the radiation, the scattered ray component of the radiation is also absorbed by the contrast agent. As a result, the scattered ray component included in a blood vessel region injected with the contrast agent on the live image G2 is less than the scattered ray component of a blood vessel region on the mask image G1.

Further, in the live image G2, the behavior of the scattered ray is different between the scattered ray component generated until the scattered ray reaches the blood vessel injected with the contrast agent in the subject H and the scattered ray component generated after the scattered rays are transmitted through the blood vessel injected with the contrast agent. Specifically, the effect of absorbing the scattered rays generated between the radiation source 5 and the blood vessel by the contrast agent is large, but the scattered rays generated on a radiation detector 8 side with respect to the blood vessel are not absorbed by the contrast agent, and the influence of the scattered rays generated from the contrast agent is increased.

In a situation in which the scattered ray components included in this way are different, in a case in which the same scattered ray removal processing is performed on the mask image G1 and the live image G2, a degree of removal of the scattered ray component in the blood vessel region injected with the contrast agent is different between the mask image G1 and the live image G2. Accordingly, the contrast of the blood vessel region is different between the mask image G1 and the live image G2. As a result, in a case in which the DSA image, which is a difference image between the mask image G1 from which the scattered ray component is removed and the live image G2 from which the scattered ray component is removed, is derived as described later, an unnecessary structure such as a bone overlaps with a blood vessel injected with the contrast agent, may not be completely removed, and may remain in the DSA image. Such an unnecessary structure hinders the check of the state of the blood vessel.

In the present embodiment, the scattered ray removal unit 21 derives the scattered ray component of each of the mask image G1 and the live image G2, and removes the scattered ray components of the mask image G1 and the live image G2. In this case, in the present embodiment, the scattered ray removal unit 21 derives, for the live image G2, the first scattered ray component on the incidence side of the radiation, that is, a radiation source 5 side in the subject H with reference to the blood vessel injected with the contrast agent. In addition, the scattered ray removal unit 21 derives, for the live image G2, the second scattered ray component on the emission side of the radiation, that is, the radiation detector 8 side in the subject H with reference to the blood vessel injected with the contrast agent. Then, the scattered ray removal unit 21 removes the scattered ray component of the live image G2 based on the first scattered ray component and the second scattered ray component.

First, the removal of the scattered ray component from the mask image G1 will be described. In the present embodiment, the scattered ray removal unit 21 removes the scattered ray component from the mask image G1 using, for example, the method described in JP2015-043959A and the like. It should be noted that the method of removing the scattered ray component is not limited thereto, and any method can be used. Hereinafter, scattered ray removal processing in a case in which the method disclosed in JP2015-043959A is used will be described. In a case in which a method disclosed in JP2015-043959A or the like is used, the derivation of a body thickness distribution of the subject H and the derivation of the scattered ray component for removing the scattered ray component are performed at the same time.

It should be noted that, in a case of removing the scattered ray component, a low-frequency image representing a low-frequency component of the mask image G1 and the live image G2 may be generated to derive the body thickness distribution by using the low-frequency image.

First, the scattered ray removal unit 21 acquires a virtual model K of the subject H having an initial body thickness distribution Ts(x,y). The virtual model K is data virtually representing the subject H of which the body thickness in accordance with the initial body thickness distribution Ts(x,y) is associated with a coordinate position of each pixel of the mask image G1. It should be noted that the virtual model K of the subject H having the initial body thickness distribution Ts(x,y) is stored in the storage 13 in advance, but the virtual model K may be acquired from an external server in which the virtual model K is stored.

In addition, in the angiography apparatus 1, a source image receptor distance (SID) that is a distance between the radiation source 5 and the surface of the radiation detector 8 and a source object distance (SOD) that is a distance between the radiation source 5 and the surface of the subject H may be measured, and the initial body thickness distribution Ts(x, y) of the subject H may be calculated based on the SID and the SOD. In this case, the body thickness distribution can be obtained by subtracting the SOD from the SID.

Next, as shown in Expression (1) and Expression (2), the scattered ray removal unit 21 derives an estimated primary ray image Ip(x,y) obtained by estimating a primary ray image obtained by imaging the virtual model K and an estimated scattered ray image Is(x,y) obtained by estimating a scattered ray image obtained by imaging the virtual model K, based on the virtual model K. Further, as shown in Expression (3), the scattered ray removal unit 21 derives an image obtained by combining the estimated primary ray image Ip(x,y) and the estimated scattered ray image Is(x,y) as an estimated image Im(x,y) in which the mask image G1 obtained by imaging the subject H is estimated.

$$I p ( x , y ) = I o ( x , y ) \times exp ( - μ l s \times T ( x , y ) ) \qquad ( 1 )$$

$$Is ( x , y ) = Io ( x , y ) * So ( T ( x , y ) ) \qquad ( 2 )$$

$$Im ( x , y ) = Is ( x , y ) + Ip ( x , y ) \qquad ( 3 )$$

Here, (x,y) is coordinates of the pixel position of the mask image G1, Ip(x,y) is a primary ray component at the pixel position (x,y), Is(x,y) is the scattered ray component at the pixel position (x,y), Io(x,y) is an incident dose on the surface of the subject H at the pixel position (x,y), μls is an attenuation coefficient of the subject H, and Sσ(T(x,y)) is a convolution kernel representing the characteristics of the scattering according to the body thickness distribution T(x,y) of the subject H at the pixel position (x,y). It should be noted that, in a case of deriving the first estimated image Im(x,y), the initial body thickness distribution Ts(x,y) is used as the body thickness distribution T(x,y) in Expression (1) and Expression (2). Expression (1) is based on a known exponential attenuation law, and Expression (2) is based on a method described in “J M Boon et al, An analytical model of the scattered radiation distribution in diagnostic radiology, Med. Phys. 15(5), September/October 1988 (Reference 1). It should be noted that the incident dose Io(x,y) on the surface of the subject H is the irradiation dose that is derived based on the imaging conditions. In addition, the attenuation coefficient μls of the subject H in Expression (1) is an attenuation coefficient of a soft tissue for the mask image G1 of the subject H.

Further, * in Expression (2) is an operator representing a convolution operation. The properties of the kernel also change depending on a distribution of an irradiation field in the angiography apparatus 1 (in a case in which an irradiation field stop is used), a distribution of a composition of the subject H, the irradiation dose during the imaging, the tube voltage, the imaging distance, the characteristics of the radiation detector 8 used in the imaging unit 6, and the like, in addition to the body thickness of the subject H. According to the method described in Reference 1, the scattered rays can be approximated by convolution of a point spread function (Sσ(T(x,y)) in Expression (3)) with respect to the primary rays. It should be noted that Sσ(T(x,y)) can be experimentally obtained according to the irradiation field information, the subject information, the imaging conditions, and the like.

In the present embodiment, Sσ(T(x,y)) may be calculated based on the irradiation field information, the subject information, and the imaging conditions during the imaging. However, a table in which various types of irradiation field information, various types of subject information, and various imaging conditions are associated with Sσ(T(x,y)) may be stored in the storage 13, and Sσ(T(x,y)) may be obtained based on the irradiation field information, the subject information, and the imaging conditions during the imaging with reference to this table. It should be noted that Sσ(T(x,y)) may be approximated by T(x,y).

Next, the scattered ray removal unit 21 corrects the initial body thickness distribution Ts(x,y) of the virtual model K such that a difference between the estimated image Im and the mask image G1 is reduced. The scattered ray removal unit 21 repeatedly performs the generation of the estimated image Im using the corrected body thickness distribution T(x,y) and the correction of the body thickness distribution T(x,y) until the difference between the estimated image Im and the mask image G1 satisfies a predetermined termination condition. The scattered ray removal unit 21 subtracts the scattered ray component Is(x,y) derived by Expression (2) in a case in which the termination condition is satisfied from the mask image G1. It should be noted that the scattered ray component derived for the mask image G1 will be referred to as a scattered ray component Is1(x,y) in the following description. Accordingly, the scattered ray component included in the mask image G1 is removed. G11 is used as a reference numeral of a processed mask image from which the scattered ray component is removed. A processed mask image G11 is an example of a pre-contrast processed radiation image according to the present disclosure.

Here, since the distance between the subject H and the radiation detector 8 is relatively large, the air is interposed in the angiography apparatus 1. The air has unique radiation characteristics. Therefore, the radiation quality of the primary ray component and the scattered ray component transmitted through the subject H change according to the radiation characteristics of the air by transmitting through the air. Therefore, in the present embodiment, in a case in which the scattered ray component is removed, it is preferable to take into account the radiation characteristics of the air interposed between the subject H and the radiation detector 8.

As a method of removing the scattered rays by taking into account the radiation characteristics of the air, for example, the method described in WO2021/100413A can be used. Specifically, for the air interposed between the subject H and the radiation detector 8, the primary ray transmittance and the scattered ray transmittance of the radiation are generated in advance as a table or the like according to the thicknesses of various types of air, various imaging conditions, and the body thickness distribution of the subject H, and are stored in the storage 13. The thickness of the air is a distance d (see FIG. 1) between the imaging table 7 and the radiation detector 8, and may be acquired by measuring in advance.

In this case, in a case of estimating the body thickness distribution of the subject H and removing the scattered rays, the scattered ray removal unit 21 refers to the table to acquire the radiation characteristics of the air according to the body thickness distribution, that is, the primary ray transmittance and the scattered ray transmittance of the radiation. In addition, the scattered ray removal unit 21 acquires an estimated primary ray image and an estimated scattered ray image using the acquired radiation characteristics, imaging conditions, and body thickness distribution, and generates an estimated image by adding the estimated primary ray image and the estimated scattered ray image. Further, the scattered ray removal unit 21 repeatedly generates the estimated image and corrects the body thickness distribution until a difference between the estimated image and the mask image G1 satisfies the predetermined termination condition. Then, the scattered ray removal unit 21 subtracts the estimated scattered ray image in a case in which the body thickness distribution satisfying the termination condition is acquired from the mask image G1 to remove the scattered ray component from the mask image G1. As a result, the scattered ray component can be removed from the mask image G1 by taking into account the radiation characteristics of the air interposed between the subject H and the radiation detector 8.

Next, the removal of the scattered ray component from the live image G2 will be described. In the present embodiment, the scattered ray removal unit 21 derives, for the live image G2, the scattered ray component separately in the blood vessel region injected with the contrast agent and other regions other than the blood vessel region. First, the derivation of the scattered ray component of the blood vessel region will be described. In order to derive the scattered ray component of the blood vessel region, the scattered ray removal unit 21 first acquires the position information representing the position of the blood vessel on the transmission path of the radiation in the subject H. The position information of the blood vessel can be acquired based on a three-dimensional image of the subject H acquired by imaging the subject H with a computed tomography (CT) apparatus, a magnetic resonance imaging (MRI) apparatus, or the like.

FIG. 4 is a diagram for describing the position information of the blood vessel. In FIG. 4, an axial cross section in the three-dimensional image is schematically shown for description. The upper side in FIG. 4 is the front side of the subject H. As shown in FIG. 4, in the three-dimensional image, a blood vessel 30 of the subject H can be extracted to obtain a center line 31 of the blood vessel. In FIG. 4, the blood vessel 30 is, for example, the abdominal aorta. Since the subject H is in a supine position in a case of capturing the three-dimensional image, a distance z1 from the body surface of the subject H on the front side to the center line 31 of the blood vessel 30 and a distance z2 from the body surface of the subject H on the rear side to the center line 31 of the blood vessel 30 on the perpendicular line passing through the center line 31 of the blood vessel 30 can be derived as the position information of the blood vessel. The former is referred to as a first distance, and the latter is referred to as a second distance.

In addition, since the subject H is in a supine position in a case of capturing the three-dimensional image, in a case in which a horizontal plane 32 passing through the center line 31 is set in the blood vessel 30 and a perpendicular line is set on the horizontal plane 32, in the blood vessel 30, the first distance z1 and the second distance z2 to the horizontal plane 32 from each of two points where the perpendicular line intersects the body surface of the subject H on the front side and the rear side can be derived as the position information of the blood vessel.

In the CT apparatus and the angiography apparatus 1 for acquiring the three-dimensional image, the subject H is imaged in a supine state. Therefore, the first distance z1 derived using the three-dimensional image is the body thickness on a radiation incidence side in the subject H with reference to the center line 31 of the blood vessel 30 for the live image G2. In addition, the second distance z2 is the body thickness on an emission side of the radiation in the subject H with reference to the center line 31 of the blood vessel 30 for the live image G2.

In the present embodiment, the three-dimensional image of the subject H is acquired in advance, and the first distance z1 and the second distance z2 to each point on the horizontal plane 32 corresponding to the center line 31 of the blood vessel 30 injected with the contrast agent are derived in advance as the position information of the blood vessel and stored in the storage 13.

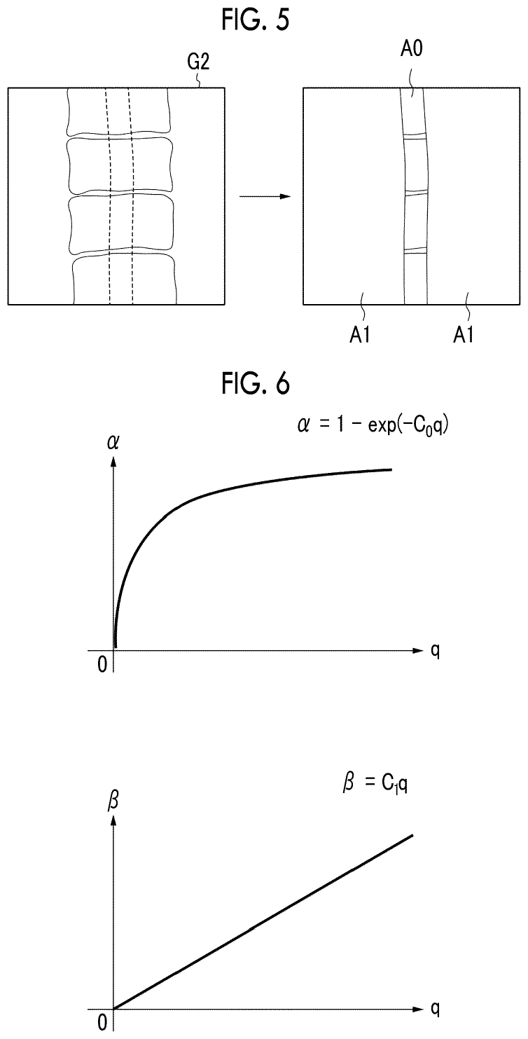

The scattered ray removal unit 21 extracts the blood vessel region from the live image G2 in a case of removing the scattered ray component from the live image G2. FIG. 5 is a diagram for describing the extraction of the blood vessel region. As shown in FIG. 5, since the blood vessel region is contrasted in the live image G2, the brightness is higher than the surrounding region. Therefore, the scattered ray removal unit 21 extracts, as a blood vessel region A0, a region having a brightness higher than a predetermined threshold value Th1 in the live image G2. The blood vessel region may be extracted using an extraction model that has been subjected to machine learning to extract the blood vessel region A0. As a result, the live image G2 is divided into the blood vessel region A0 and other regions A1 other than the blood vessel region A0.

In the blood vessel region A0 in the live image G2, the scattered ray removal unit 21 derives a first scattered ray component Is21(x, y) on the radiation incidence side in the subject H and a second scattered ray component Is22(x, y) on the radiation emission side in the subject H with reference to the blood vessel. Then, as shown in Expression (4), a scattered ray component Is2(x, y) of the live image G2 is derived by performing weighted addition of the first scattered ray component Is21(x, y) and the second scattered ray component Is22(x, y). Coefficients α and β will be described later.

$$Is 2 ( x , y ) = ( 1 - α ) \cdot Is 21 ( x , y ) + ( 1 + β ) \cdot Is 22 ( x , y ) \qquad ( 4 )$$

The scattered ray removal unit 21 derives the first scattered ray component Is21(x, y) using the first body thickness T1 from the body surface of the subject H on a radiation source side to the horizontal plane 32 corresponding to the center line 31 of the blood vessel 30 according to Expression (5). In addition, the scattered ray removal unit 21 derives the second scattered ray component Is22(x, y) using the second body thickness T2 from the body surface of the subject H on the detector side to the horizontal plane 32 corresponding to the center line 31 of the blood vessel 30 according to Expression (6).

$$Is 21 ( x , y ) = Io ( x , y ) * So ( T 1 ( x , y ) ) \qquad ( 5 )$$

$$Is 22 ( x , y ) = Io ( x , y ) * So ( T 2 ( x , y ) ) \qquad ( 6 )$$

In the present embodiment, the scattered ray removal unit 21 acquires the position information of the blood vessel stored in the storage 13. Then, the scattered ray removal unit 21 performs registration between the live image G2 and the three-dimensional image acquired in advance, and uses the first distance z1 and the second distance z2 at the pixel position of the three-dimensional image corresponding to the pixel position of the live image G2 as the first body thickness T1 and the second body thickness T2, respectively. In a case of deriving the first scattered ray component Is21(x, y) and the second scattered ray component Is22(x, y), it is preferable to take into account the thickness of the air between the subject H and the radiation detector 8, similarly to the mask image G1.

α and β in Expression (4) are coefficients determined according to the concentration of the contrast agent. A scattered ray absorbed by the contrast agent is taken into account as the coefficient α, is 0 in a case where there is no contrast agent, and approaches 1 as the amount of the contrast agent increases. A scattered ray generated from the contrast agent is taken into account as the coefficient β, is 0 in a case where the contrast agent is not injected, and increases in proportion to the amount of the contrast agent. FIG. 6 is a diagram showing a relationship between the amount of the contrast agent and the coefficient α and the coefficient β. α is 1−exp(−C₀q), and β is C₁q. q is the amount of the contrast agent and is derived by multiplying the contrast agent concentration by the blood vessel diameter. The contrast agent concentration may be acquired by receiving an input of the concentration of the contrast agent to be used from the input device 15, and the blood vessel diameter may be acquired by measuring the blood vessel diameter in the three-dimensional image. C₀ and C₁ are constants, and are derived by actually measuring the scattered rays by capturing an image of a phantom that imitates a human body injected with the contrast agent in advance.

For the other regions A1 other than the blood vessel region A0 in the live image G2, the scattered ray removal unit 21 derives the scattered ray component Is2(x, y) using the live image G2, similarly to the mask image G1. In this case, the body thickness used in Expression (2) may be the body thickness T(x, y) that satisfies the termination condition in a case of deriving the scattered ray component Is(x, y) of the mask image G1. In addition, in this case, it is preferable to derive the scattered ray component by taking into account the thickness of the air between the subject H and the radiation detector 8, similarly to the mask image G1. The scattered ray component Is2(x, y) for the other regions A1 is an example of other scattered ray components of the present disclosure.

The scattered ray removal unit 21 may derive the first scattered ray component Is21(x, y) on the radiation incidence side in the subject H and the second scattered ray component Is22(x, y) on the radiation emission side in the subject H with reference to the center line 31 of the blood vessel 30 in the other regions A1 of the live image G2, and derive the scattered ray component Is2(x, y) in Expression (4) described above by setting α=0 and β=0.

The scattered ray removal unit 21 derives a processed live image from which the scattered ray component is removed by subtracting the scattered ray component Is2(x, y) derived in the blood vessel region A0 and the other regions A1 other than the blood vessel region A0 from the live image G2. G22 is used as a reference numeral of a processed live image from which the scattered ray component is removed. A processed live image G22 is an example of a post-contrast processed radiation image according to the present disclosure.

As shown in Expression (7), the image derivation unit 22 derives a difference image in which the blood vessel region in the subject H injected with the contrast agent is emphasized, that is, a DSA image Gp by subtracting the processed mask image G11 from the processed live image G22.

$$Gp ( x , y ) = G 22 ( x , y ) - G 11 ( x , y ) \qquad ( 7 )$$

The display controller 23 displays the DSA image Gp on the display 14. The doctor performs the examination and the treatment of the blood vessel while viewing the DSA image Gp displayed on the display.

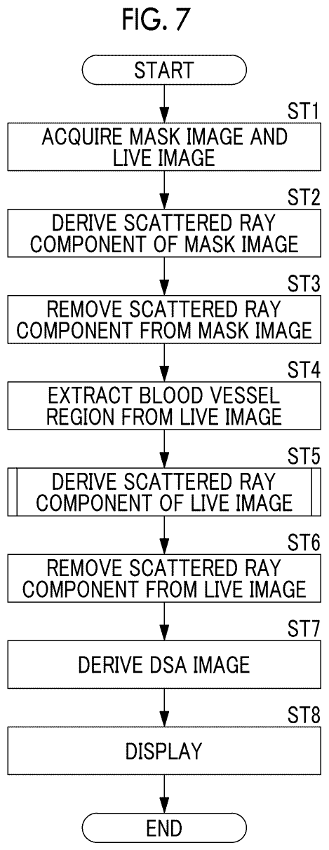

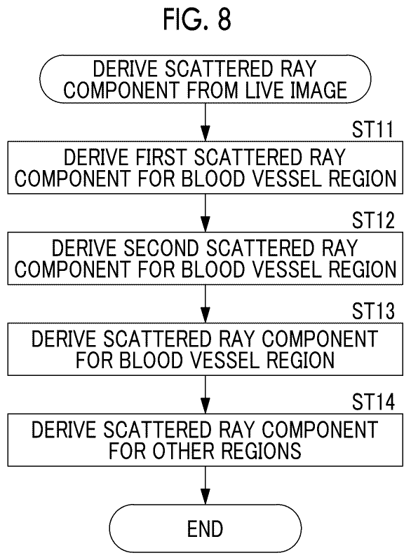

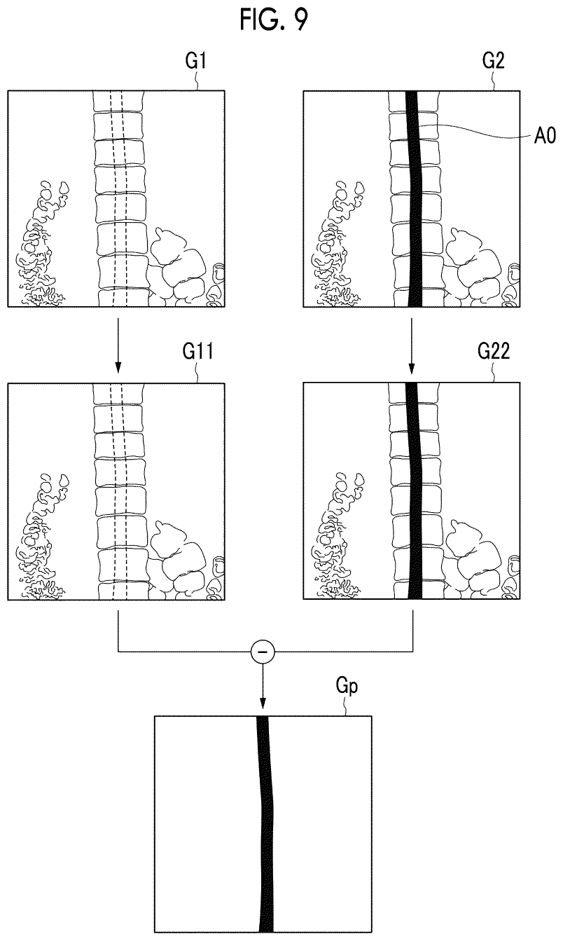

Next, processing performed in the present embodiment will be described. FIGS. 7 and 8 are flowcharts showing the processing performed in the present embodiment, and FIG. 9 is a conceptual diagram of the processing performed in the present embodiment. It should be noted that it is assumed that the mask image G1 and the live image G2 are acquired by the imaging, and are stored in the storage 13.

In a case in which an instruction to start the processing is input from the input device 15, the image acquisition unit 20 acquires the mask image G1 and the live image G2 from the storage 13 (step ST1). Next, the scattered ray removal unit 21 derives the scattered ray component Is1 included in the mask image G1 (step ST2), and derives the processed mask image G11 by removing the scattered ray component of the mask image G1 by subtracting the derived scattered ray component Is1 from the mask image G1 (step ST3).

Next, the scattered ray removal unit 21 extracts the blood vessel region A0 injected with the contrast agent from the live image G2 (step ST4). The scattered ray removal unit 21 derives the scattered ray component for the live image G2 (step ST5).

Proceeding to FIG. 8, the scattered ray removal unit 21 derives, for the blood vessel region A0, the first scattered ray component on the incidence side of the radiation, that is, the radiation source 5 side in the subject H (step ST11). In addition, the scattered ray removal unit 21 derives, for the blood vessel region A0, the second scattered ray component on the emission side of the radiation, that is, the radiation detector 8 side in the subject H with reference to the blood vessel region injected with the contrast agent (step ST12). Then, for the blood vessel region A0, the scattered ray component Is2 is derived by adding the first scattered ray component and the second scattered ray component (step ST13). On the other hand, for the other regions A1 other than the blood vessel region A0, the scattered ray component Is2 is derived in the same manner as the mask image G1 (step ST14), and the derivation of the scattered ray component from the live image is terminated.

Returning to FIG. 7, the scattered ray removal unit 21 derive the processed live image G22 by subtracting the derived scattered ray component Is2(x, y) from the live image G2 to remove the scattered ray component of the live image G2 (step ST6). Then, the image derivation unit 22 derives the DSA image Gp by subtracting the processed mask image G11 from the processed live image G22 (step ST7). The display controller 23 displays the DSA image Gp on the display 14 (step ST8), and terminates the processing.

As described above, in the present embodiment, for the live image G2, the first scattered ray component Is21 on the incidence side of the radiation in the subject H and the second scattered ray component Is22 on the emission side of the radiation in the subject H are derived with reference to the blood vessel region injected with the contrast agent, and the scattered ray component Is2 of the live image G2 is removed based on the first scattered ray component Is21 and the second scattered ray component Is22. Here, the first scattered ray component Is21 represents a scattered ray on the radiation source 5 side with reference to the blood vessel injected with the contrast agent, and the second scattered ray component Is22 represents a scattered ray on the radiation detector 8 side with reference to the blood vessel injected with the contrast agent. Therefore, even in a case where the behavior of the scattered ray is different between the scattered ray component generated until the scattered ray reaches the blood vessel injected with the contrast agent in the subject H and the scattered ray component generated after the scattered ray is transmitted through the blood vessel, the scattered ray component can be accurately derived by taking into account the influence thereof, and the scattered ray component of the live image G2 can be removed. Therefore, according to the present embodiment, in a case of deriving the difference image, such as the DSA image Gp, since it is possible to suppress the structure, such as the bone that overlaps with the contrast agent in the region of the contrast agent, from remaining, the unnecessary structure from hindering the check of the state of the blood vessel can be prevented.

In the above-described embodiment, the scattered ray component is removed in the entire region of the live image G2, but the present disclosure is not limited thereto. The processed live image G22 may be derived by deriving the scattered ray component Is2(x, y) using Expression (4) only in the blood vessel region A0 in the live image G2 and removing the scattered ray component Is2(x, y) only in the blood vessel region A0 in the live image G2. In this case, for the mask image G1, the processed mask image G11 may be derived by extracting the blood vessel region and removing the scattered ray component in the same manner as described above only in the blood vessel region of the mask image G1, and the DSA image Gp may be derived using Expression (7) from the processed live image G22 in which the scattered ray component is removed only in the blood vessel region A0 and the processed mask image G11 in which the scattered ray component is removed only in the blood vessel region. Even in this case, it is possible to suppress the structure, such as the bone that overlaps with the contrast agent in the blood vessel region A0 injected with the contrast agent, from remaining.

The radiation in the embodiment described above is not particularly limited, and a-rays or γ-rays can be used in addition to X-rays.

In addition, in the embodiment described above, the blood vessel is used as the tubular structure, but the present disclosure is not limited to this. It is possible to target any tubular structure in which examination and treatment using a contrast agent are performed, such as an esophagus, a large intestine, a pancreatic duct, and a bile duct. In addition, endoscopic retrograde cholangiopancreatography (ERCP) is performed as the examination and treatment in which the contrast agent is injected into the pancreatic duct and the bile duct. The endoscopic retrograde cholangiopancreatography is a method of inserting an endoscope through the mouth, advancing the endoscope through the esophagus and stomach to the duodenum, directly injecting the contrast agent into the bile duct or pancreatic duct through a thin tube, and examining or treating an abnormality of the gall bladder, the bile duct, and the pancreatic duct.

In the present embodiment, each processing is executed by any computer. In addition, any computer may execute these types of processing by a processor as hardware, a program as software, or a combination thereof. In that case, the processor is configured to execute various types of processing in the present embodiment in cooperation with the program, and can function as each unit or each means in the present embodiment. In addition, the execution order of the processing by the processor is not limited to the order described above and may be appropriately changed. Any computer may be a general-purpose computer, a computer for a specific use, a workstation, or another system capable of executing each processing.

The processor may be configured by one or a plurality of pieces of hardware, and the type of hardware is not limited. For example, the processor may be configured by hardware such as a central processing unit (CPU), a micro processing unit (MPU), a programmable logic device such as a field programmable gate array (FPGA), a dedicated circuit for executing specific processing such as an application specific integrated circuit (ASIC), a graphic processing unit (GPU), or a neural processing unit (NPU). In addition, the types of hardware may be a combination of different types of hardware. In a case where a plurality of pieces of hardware are configured to execute one or a plurality of types of processing of a certain processor, the plurality of pieces of hardware may be present in devices physically separated from each other, or may be present in the same device. In addition, in any of the embodiments, the order of each processing by the processor is not limited to the above order, and may be appropriately changed. The hardware is configured by an electric circuit (circuitry) in which circuit elements such as semiconductor elements are combined.

Furthermore, the program may be software such as firmware or a microcode. In addition, the program may be, for example, a program module group, and each function thereof may be realized by a processor configured to execute each function. The program may be a program code or a plurality of code segments stored in one or a plurality of non-transitory computer-readable media (for example, a storage medium or other storage). The program may be divided and stored in the plurality of non-transitory computer-readable media present in devices physically separated from each other. The program code or code segment may represent any combination of a procedure, a function, a subprogram, a routine, a subroutine, a module, a software package, a class, or an instruction, a data structure, or a program statement. The program code or code segment may be connected to another code segment or a hardware circuit by transmitting and receiving information, data, an argument, a parameter, or a content of a memory.

In addition, in the above-described embodiment, the aspect in which the radiation image processing program 12 is stored (installed) in the storage 13 in advance has been described, but the present disclosure is not limited thereto. The radiation image processing program 12 may be provided in a form recorded in a recording medium, such as a compact disc read-only memory (CD-ROM), a digital versatile disc read-only memory (DVD-ROM), and a universal serial bus (USB) memory. Further, the radiation image processing program 12 may also be downloaded from an external device via the network.

The technology of the present disclosure extends to all program products. The program product includes products in all aspects for providing a program. For example, the program product includes a program provided through a network such as the Internet, and a non-transitory computer-readable recording medium such as a CD-ROM, a DVD, and a USB memory in which the program is stored.

The supplementary notes of the present disclosure will be described below.

### Supplementary Note 1

A radiation image processing device including:
a processor,
in which the processor is configured to:
   acquire a post-contrast radiation image by performing radiography on a subject including a tubular structure injected with a contrast agent;
   derive a first scattered ray component on an incidence side of radiation of the subject and a second scattered ray component on an emission side of the radiation of the subject with reference to the tubular structure; and
   derive a post-contrast processed radiation image by removing a scattered ray component of the post-contrast radiation image based on the first scattered ray component and the second scattered ray component in a region of the tubular structure injected with the contrast agent in the post-contrast radiation image.

### Supplementary Note 2

The radiation image processing device according to Supplementary Note 1, in which the processor is configured to derive each of the first scattered ray component and the second scattered ray component based on a first body thickness of the subject on the incidence side of the radiation with reference to the tubular structure on a transmission path of the radiation in the subject and a second body thickness on the emission side of the radiation with reference to the tubular structure on the transmission path.

### Supplementary Note 3

The radiation image processing device according to Supplementary Note 1 or 2, in which the processor is configured to derive the first scattered ray component based on a first coefficient that is determined according to a concentration of the contrast agent and that takes into account a scattered ray absorbed by the contrast agent, and derive the second scattered ray component based on a second coefficient that is determined according to the concentration of the contrast agent and that takes into account a scattered ray generated from the contrast agent.

### Supplementary Note 4

The radiation image processing device according to any one of Supplementary Notes 1 to 3, in which the processor is configured to derive other scattered ray components in other regions other than the tubular structure injected with the contrast agent in the post-contrast radiation image, and derive the post-contrast processed radiation image by removing the scattered ray components in the other regions in the post-contrast radiation image based on the other scattered ray components.

### Supplementary Note 5

The radiation image processing device according to Supplementary Note 4,
in which the processor is configured to:
   derive the first scattered ray component on the incidence side of the radiation of the subject and the second scattered ray component on the emission side of the radiation of the subject with reference to the tubular structure in the other regions; and
   derive the other scattered ray components based on the first scattered ray component and the second scattered ray component.

### Supplementary Note 6

The radiation image processing device according to any one of Supplementary Notes 1 to 3, in which the processor is configured to derive the post-contrast processed radiation image by removing the scattered ray component of the post-contrast radiation image only in the region of the tubular structure in the post-contrast radiation image.

### Supplementary Note 7

The radiation image processing device according to Supplementary Note 4 or 5,
in which the processor is configured to:
   acquire a pre-contrast radiation image by performing the radiography on the subject including the tubular structure before the contrast agent is injected;
   derive a pre-contrast scattered ray component included in the pre-contrast radiation image;
   derive a pre-contrast processed radiation image by removing a scattered ray component of the pre-contrast radiation image based on the pre-contrast scattered ray component; and
   derive a difference image between the pre-contrast processed radiation image and the post-contrast processed radiation image.

### Supplementary Note 8

The radiation image processing device according to Supplementary Note 6,
in which the processor is configured to:
   acquire a pre-contrast radiation image by performing the radiography on the subject including the tubular structure before the contrast agent is injected;
   derive a pre-contrast scattered ray component included in the region of the tubular structure of the pre-contrast radiation image;
   derive a pre-contrast processed radiation image by removing a scattered ray component in the region of the tubular structure of the pre-contrast radiation image based on the pre-contrast scattered ray component; and
   derive a difference image between the pre-contrast processed radiation image and the post-contrast processed radiation image.

### Supplementary Note 9

A radiation image processing method including:
via a computer,
acquiring a post-contrast radiation image by performing radiography on a subject including a tubular structure injected with a contrast agent;
deriving a first scattered ray component on an incidence side of radiation of the subject and a second scattered ray component on an emission side of the radiation of the subject with reference to the tubular structure; and
deriving a post-contrast processed radiation image by removing a scattered ray component of the post-contrast radiation image based on the first scattered ray component and the second scattered ray component in a region of the tubular structure injected with the contrast agent in the post-contrast radiation image.

### Supplementary Note 10

A radiation image processing program causing a computer to execute:
a procedure of acquiring a post-contrast radiation image by performing radiography on a subject including a tubular structure injected with a contrast agent;
a procedure of deriving a first scattered ray component on an incidence side of radiation of the subject and a second scattered ray component on an emission side of the radiation of the subject with reference to the tubular structure; and
a procedure of deriving a post-contrast processed radiation image by removing a scattered ray component of the post-contrast radiation image based on the first scattered ray component and the second scattered ray component in a region of the tubular structure injected with the contrast agent in the post-contrast radiation image.

What is claimed is:

1. A radiation image processing device comprising:
a processor,
wherein the processor is configured to:
acquire a post-contrast radiation image by performing radiography on a subject including a tubular structure injected with a contrast agent;
derive a first scattered ray component on an incidence side of radiation of the subject and a second scattered ray component on an emission side of the radiation of the subject with reference to the tubular structure; and
derive a post-contrast processed radiation image by removing a scattered ray component of the post-contrast radiation image based on the first scattered ray component and the second scattered ray component in a region of the tubular structure injected with the contrast agent in the post-contrast radiation image.

2. The radiation image processing device according to claim 1,
wherein the processor is configured to derive each of the first scattered ray component and the second scattered ray component based on a first body thickness of the subject on the incidence side of the radiation with reference to the tubular structure on a transmission path of the radiation in the subject and a second body thickness on the emission side of the radiation with reference to the tubular structure on the transmission path.

3. The radiation image processing device according to claim 1,
wherein the processor is configured to derive the first scattered ray component based on a first coefficient that is determined according to a concentration of the contrast agent and that takes into account a scattered ray absorbed by the contrast agent, and derive the second scattered ray component based on a second coefficient that is determined according to the concentration of the contrast agent and that takes into account a scattered ray generated from the contrast agent.

4. The radiation image processing device according to claim 1,
wherein the processor is configured to derive other scattered ray components in other regions other than the tubular structure injected with the contrast agent in the post-contrast radiation image, and derive the post-contrast processed radiation image by removing the scattered ray components in the other regions in the post-contrast radiation image based on the other scattered ray components.

5. The radiation image processing device according to claim 4,
wherein the processor is configured to:
derive the first scattered ray component on the incidence side of the radiation of the subject and the second scattered ray component on the emission side of the radiation of the subject with reference to the tubular structure in the other regions; and
derive the other scattered ray components based on the first scattered ray component and the second scattered ray component.

6. The radiation image processing device according to claim 1,
wherein the processor is configured to derive the post-contrast processed radiation image by removing the scattered ray component of the post-contrast radiation image only in the region of the tubular structure in the post-contrast radiation image.

7. The radiation image processing device according to claim 4,
wherein the processor is configured to:
acquire a pre-contrast radiation image by performing the radiography on the subject including the tubular structure before the contrast agent is injected;
derive a pre-contrast scattered ray component included in the pre-contrast radiation image;
derive a pre-contrast processed radiation image by removing a scattered ray component of the pre-contrast radiation image based on the pre-contrast scattered ray component; and
derive a difference image between the pre-contrast processed radiation image and the post-contrast processed radiation image.

8. The radiation image processing device according to claim 5,
wherein the processor is configured to:
acquire a pre-contrast radiation image by performing the radiography on the subject including the tubular structure before the contrast agent is injected;
derive a pre-contrast scattered ray component included in the pre-contrast radiation image;
derive a pre-contrast processed radiation image by removing a scattered ray component of the pre-contrast radiation image based on the pre-contrast scattered ray component; and
derive a difference image between the pre-contrast processed radiation image and the post-contrast processed radiation image.

9. The radiation image processing device according to claim 6,
wherein the processor is configured to:
acquire a pre-contrast radiation image by performing the radiography on the subject including the tubular structure before the contrast agent is injected;
derive a pre-contrast scattered ray component included in the region of the tubular structure of the pre-contrast radiation image;
derive a pre-contrast processed radiation image by removing a scattered ray component in the region of the tubular structure of the pre-contrast radiation image based on the pre-contrast scattered ray component; and
derive a difference image between the pre-contrast processed radiation image and the post-contrast processed radiation image.

10. A radiation image processing method comprising:
via a computer,
acquiring a post-contrast radiation image by performing radiography on a subject including a tubular structure injected with a contrast agent;
deriving a first scattered ray component on an incidence side of radiation of the subject and a second scattered ray component on an emission side of the radiation of the subject with reference to the tubular structure; and
deriving a post-contrast processed radiation image by removing a scattered ray component of the post-contrast radiation image based on the first scattered ray component and the second scattered ray component in a region of the tubular structure injected with the contrast agent in the post-contrast radiation image.

11. A non-transitory computer-readable storage medium that stores a radiation image processing program causing a computer to execute:
a procedure of acquiring a post-contrast radiation image by performing radiography on a subject including a tubular structure injected with a contrast agent;
a procedure of deriving a first scattered ray component on an incidence side of radiation of the subject and a second scattered ray component on an emission side of the radiation of the subject with reference to the tubular structure; and
a procedure of deriving a post-contrast processed radiation image by removing a scattered ray component of the post-contrast radiation image based on the first scattered ray component and the second scattered ray component in a region of the tubular structure injected with the contrast agent in the post-contrast radiation image.
